(19) United States
(12) Patent Application Publication
(10) Pub. No.: US 2025/0005424 A1
(43) Pub. Date: Jan. 2, 2025

(54) ENHANCED DECODING OF QUANTUM ERROR CORRECTION CODES WITH IN-PHASE AND QUADRATURE INFORMATION

(71) Applicant: Google LLC, Mountain View, CA (US)

(72) Inventors: Michael Gabriel Newman, Palo Alto, CA (US); Kevin Satzinger, Goleta, CA (US); Daniel Thomas Sank, Goleta, CA (US); Nathan Cody Jones, Santa Barbara, CA (US)

(21) Appl. No.: 18/758,727

(22) Filed: Jun. 28, 2024

Related U.S. Application Data
(60) Provisional application No. 63/523,733, filed on Jun. 28, 2023.

(51) Int. Cl. G06N 10/70; G06N 10/60

(52) U.S. Cl. CPC G06N 10/70; G06N 10/60

(57) ABSTRACT

Methods, systems, and apparatus for enhanced decoding using in-phase and quadrature information. In one aspect, a method includes obtaining in-phase and quadrature values for multiple measurement operations in a quantum error correction code for a quantum computation; classifying measurement outcomes of the multiple measurement operations using respective in-phase and quadrature values; generating a detector graph of nodes and edges, wherein the detector graph labels detection events that occur in the classified measurement outcomes; assigning weights to the edges of the detector graph using posterior probability distributions of the classified measurement outcomes to generate a weighted detector graph; and executing a decoding process on the weighted detector graph to compute a decoding output of the decoding process, wherein the decoding output predicts an occurrence of errors in the quantum computation.

### CROSS-REFERENCE TO RELATED APPLICATIONS

This application claims the benefit under 35 U.S.C. § 119 (e) of U.S. Patent Application No. 63/523,733 filed Jun. 28, 2023. The disclosure of the foregoing application is incorporated herein by reference in its entirety for all purposes.

### BACKGROUND

This specification relates to quantum computing and machine learning.

Quantum computing provides a means to solve certain problems that cannot be solved in a reasonable period of time using conventional classical computers. These problems include factoring very large numbers into their primes and searching large, unstructured data sets. A number of physical systems are being explored for their use in quantum computing, including ions, spins in semiconductors, and superconducting circuits. However, these systems do not perform sufficiently well to serve directly as computational qubits. For example, single two-state physical systems, which can be used as physical qubits, cannot reliably encode and retain information for long enough to be useful, e.g., due to noise.

Quantum error correction is a technology that can enable a quantum computer to reliably execute a quantum algorithm despite noise afflicting its qubits. A decoder is a key component of quantum error correction schemes whose role is to identify errors as they accumulate in the quantum computer. Typically, the decoder takes as an input a syndrome, which is binary measurement data extracted from quantum parity check measurements and returns as output an estimation of error. Given this estimation, the effect of the error can be reversed.

### SUMMARY

This specification describes methods, systems and apparatus for enhanced decoding using in-phase and quadrature (I/Q) information.

One innovative aspect of the subject matter described in this specification can be implemented in a method that includes obtaining in-phase and quadrature values for multiple measurement operations in a quantum error correction code for a quantum computation; classifying measurement outcomes of the multiple measurement operations using respective in-phase and quadrature values; generating a detector graph of nodes and edges, wherein the detector graph labels detection events that occur in the classified measurement outcomes; assigning weights to the edges of the detector graph using posterior probability distributions of the classified measurement outcomes to generate a weighted detector graph; and executing a decoding process on the weighted detector graph to compute a decoding output of the decoding process, wherein the decoding output predicts an occurrence of errors in the quantum computation.

Other implementations of these aspects include corresponding computer systems, apparatus, and computer programs (for example, recorded on one or more computer storage devices), each configured to perform the actions of the methods. A system of one or more classical computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations the method further comprises using the in-phase and quadrature values to compute probability density functions for the classified measurement outcomes, optionally wherein computing the probability density functions for the measurement outcomes comprises using kernel density estimation techniques.

In some implementations classifying measurement outcomes of the multiple measurement operations using respective in-phase and quadrature values comprises, for each measurement operation: computing a conditional probability that the measurement operation produces a first outcome given a respective in-phase and quadrature value assuming a uniform prior probability distribution for the measurement operation; and in response to determining that the conditional probability is greater than or equal to a predetermined threshold, classifying the measurement outcome as the first outcome; or in response to determining that the conditional probability is less than the predetermined threshold, classifying the measurement outcome as a second outcome.

In some implementations computing a conditional probability that the measurement operation produces a first outcome given a respective in-phase and quadrature value assuming a uniform prior probability distribution comprises computing:

$$P r ( 1 \vert obs ) = \frac{P D {F}_{1} ( o b s )}{P D {F}_{0} ( o b s ) + P D {F}_{1} ( o b s )}$$

where Pr(1|obs) represents the conditional probability that the measurement operation produces outcome 1 given an in-phase and quadrature value obs, PDF₁(obs) represents a value of a probability density function PDF₁ for the outcome 1 given the value obs, and PDF₀(obs) represents a value of a probability density function PDF₀ for the outcome 0 given the value obs.

In some implementations classifying measurement outcomes of the multiple measurement operations using respective in-phase and quadrature values comprises, for each measurement operation: computing a conditional probability that the measurement operation produces outcome i given a respective in-phase and quadrature value assuming a prior probability distribution for the measurement operation.

In some implementations computing a conditional probability that the measurement operation produces outcome i given a respective in-phase and quadrature value assuming a uniform prior probability distribution comprises computing:

$$P r ( i \vert obs ) = \frac{{P}_{prior , i} \cdot {PDF}_{i} ( o b s )}{{\sum }_{j} {P}_{prior , j} \cdot {PDF}_{j} ( o b s )}$$

where Pr(i|obs) represents the conditional probability that the measurement operation produces outcome i given an in-phase and quadrature value obs, PDFₖ(obs) represents a value of a probability density function PDFₖ for outcome k given the value obs, and the index j represents all possible measurement outcomes.

In some implementations generating the detector graph comprises assigning the edges initial weights using component-level benchmarks without measurement error.

In some implementations assigning weights to the edges of the detector graph using posterior probability distributions of the classified measurement outcomes comprises updating the initial weights to include values of the posterior probability distributions.

In some implementations the weighted detector graph is equivalent to a detector graph generated with measurement error, wherein individual in-phase and quadrature values are used to determine measurement error probabilities.

In some implementations the in-phase and quadrature values are obtained from a quantum computing device that implements the quantum error correction code and performs the quantum computation, wherein the quantum computing device transmits 4 additional bits of in-phase and quadrature values per measurement operation.

In some implementations assigning weights to the edges of the detector graph using posterior probability distributions of the classified measurement outcomes to generate a weighted detector graph comprises updating weights of edges that are adjacent to detection events.

In some implementations assigning weights to the edges of the detector graph using posterior probability distributions of the classified measurement outcomes to generate a weighted detector graph comprises down-weighting weights of edges that are adjacent to detection events and that include leakage measurements.

In some implementations in-phase and quadrature values for a respective measurement operation are clustered into a first cluster that represents a 0 measurement outcome of the measurement operation, a 1 measurement outcome of the measurement operation, and a 2 measurement outcome of the measurement operation, wherein the 2 measurement outcome indicates leakage.

In some implementations the method further comprises using leaked state discrimination to implement a leakage-aware reweighting strategy.

In some implementations, implementation of the quantum computation and/or further quantum computations by the quantum computer can be adjusted based on the decoding output that predicts the occurrence of errors in the quantum computation. For example, the quantum computer may be calibrated, configured and/or controlled based on the decoding output.

The subject matter described in this specification can be implemented in particular ways so as to realize one or more of the following advantages.

Quantum error correction is based on learning information about errors from measurements in a quantum computing device. In particular, a decoder takes binary measurement outcomes as input and produces a logical measurement outcome as output. The success of the decoder in producing the correct logical measurement outcome depends on both the prior understanding of the quantum computing device and the sophistication of the decoding method. In practice, the quantum computing device provides rich measurement information in the form of a point in I/Q phase space. The presently described techniques use this information to improve decoding accuracy, e.g., in the presence of high measurement error rates and leakage. As such, an accurate understanding of the physical characteristics of the quantum computer can be established.

The details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example computing system for enhanced decoding of a quantum error correction code using I/Q information.

FIG. 2 shows a plot of example measured I/Q phase space data and corresponding probability density functions generated from the example measured I/Q phase space data.

FIG. 3 is a flowchart of an example process for enhancing decoding of a quantum error correction code using in-phase and quadrature information.

FIG. 4 is a plot that shows misclassification error for different error correction code distances and different transmission bit sizes.

FIG. 5 is a plot that shows misclassification error for different error correction code distances with and without using the presently described techniques for enhancing decoding using in-phase and quadrature information.

FIG. 6 is a plot that shows the detection event fraction for different error correction code distances with and without using the presently described techniques for enhancing decoding using in-phase and quadrature information.

Like reference numbers and designations in the various drawings indicate like elements.

### DETAILED DESCRIPTION

This specification describes techniques for enhancing decoding of a quantum error correction code using in-phase and quadrature (I/Q) information. For some decoders, e.g., matching-type decoders, measurement errors are distributed as a contributing error probability to different error graph edges. Usually, these edges are weighted according to an accumulated measurement error probability averaged over many shots. Instead, the presently described techniques use instance-specified I/Q points to reweight the edge according to a prior distribution on the measurement outcome. For example, if the IQ point to lie equidistant from the zero and one clouds in an I/Q plot, assuming a uniform prior, the corresponding edge would be weighted using a 50% probability, indicating a high likelihood of that type of error. For points that lie near a higher-state cloud (e.g., the 2-state), this information can be used to reweight time-like edges in the vicinity with higher probabilities. This can compensate for the long-time effects of leakage, which may persist in the data qubits and cause correlated errors across long time durations. As such, the techniques of the present disclosure can improve the ability to understand the underlying physical states of elements used in quantum computation (such as qubits) given such physical mechanisms.

In the context of superconducting qubits, e.g., transmon qubits, the three lowest-energy states |0), |1), |2) are typically considered. In a typical “discrete” point of view (where each measurement outcome is rigidly assigned to 0, 1, or 2), compromises must be made in terms of the “visibility” between the relevant states. However, in an error correction context, the typical prior probability of a qubit being leaked into |2) is ˜10₋₂ or less. By incorporating this prior and additional measurement information such as I/Q information, the demands of |2) measurement fidelity can be relaxed, which allows for optimization of the measurement pulse parameters (e.g., frequency) primarily for 0/1 measurement. In this way, improved measurement of physical states associated with the functioning of physical elements for performing quantum computation (e.g., qubits) can be obtained.

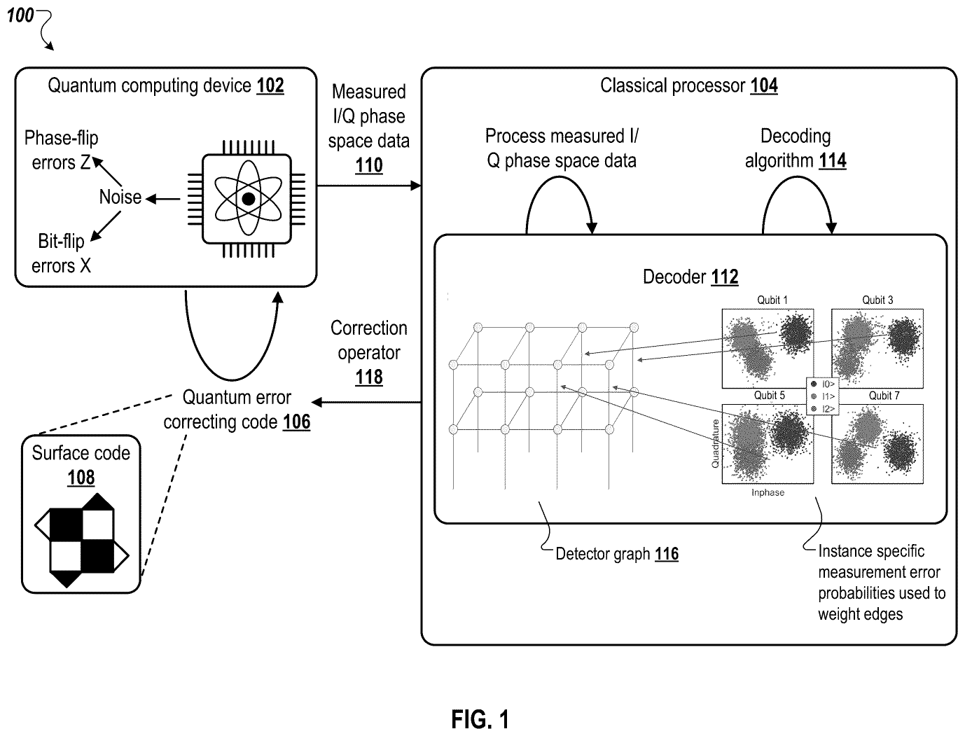

FIG. 1 is a block diagram of an example computing system 100 for enhanced decoding using I/Q information. The example computing system 100 is an example of a system implemented as classical and quantum computer programs on one or more classical computers and quantum computing devices in one or more locations, in which the systems, components, and techniques described herein can be implemented.

The example computing system 100 includes a quantum computing device 102 and a classical processor 104. For illustrative purposes, the quantum computing device 102 and classical processor 104 shown in FIG. 1 are illustrated as separate entities, however in some implementations the classical processor 104 may be included in the quantum computing device 102. For example, in some implementations the quantum computing device 102 can be directly connected to the classical processor 104. In other implementations, the quantum computing system 102 can be connected to the classical processor 104 through a network, e.g., a local area network (LAN), wide area network (WAN), the Internet, or a combination thereof.

The quantum computing device 102 includes components for performing quantum computation. For example, the quantum computing device 102 can comprise one or more physical elements, such as qubits, for implementing quantum computations. For example, the quantum computing device can include a quantum data plane that, in turn, includes multiple physical qubits. The quantum computing device 102 can also include a control and measurement plane that is configured to perform operations and measurements on the physical qubits and can also include a control processor plane that is configured to determine sequences of operations and measurements that a quantum algorithm being performed by the quantum computing system requires. The quantum computing device 102 can also include a classical computer that is in data communication with the control processor plane and facilitates user interactions and access to networks or storage. The particular type of the quantum computing device 102 can depend on the type of qubit used. In some implementations the qubits can be superconducting qubits, semiconducting qubits, photonic qubits, or atom-based qubits. For example, the qubits can include Xmon qubits, flux qubits, phase qubits, CAT qubits, or qubits with frequency interactions.

Typically, quantum computations performed by the quantum computing device 102 will be noisy due to the unavoidable presence of errors caused by, e.g., unwanted interactions between qubits, unwanted interactions with the environment (causing decoherence), faulty quantum gates or operations, or errors in the state preparation or measurement process. Example types of errors include coherent errors that act on single qubits, e.g., Pauli X-type errors called bit-flip errors that map the qubit basis states X|0 [symbol] =|1 [symbol] and X|1 [symbol] =|0 [symbol] and Pauli-Z errors called phase-flip errors that map the qubit basis states Z|0 [symbol] =|0 [symbol] and Z|1 [symbol] =−|1 [symbol] . Noise in a quantum computing device can be represented by an error model, e.g., independent error models as described in more detail below. If left unchecked, errors can destroy quantum information and render quantum computations performed by the quantum computing device 102 useless.

Therefore, the quantum computing device 102 can be configured to execute a quantum error correcting code 106 when performing quantum computations. Quantum error correcting codes encode a first number k of qubits (a Hilbert space of dimension 2^{k}) into a second number n of qubits (a Hilbert space of dimension 2ⁿ), where the second number is larger than the first number, i.e., n>k. The k qubits are data qubits that store logical information and are to be protected from error. The additional n−k qubits are ancilla qubits that are used to detect errors. Example quantum error correcting codes include Stabilizer codes, e.g., Calderbank-Shor-Steane codes or the surface code 108.

The surface code 108 encodes a logical qubit into a patch of multiple physical qubits on a lattice, e.g., a square or hex grid. The lattice includes alternating data qubits and ancilla qubits, where a qubit is placed on each edge of the lattice. The code is defined to be the ground space of the Hamiltonian H=−Σ_{v∈V}Xᵥ−Σ_{f∈F}Z_{f} where V represents vertices of the lattice, F represents faces defined by edges connecting vertices of the lattice, the operator Xᵥ is associated with vertex v and is a product of Pauli-X matrices acting on edges incident to v, and the operator Z_{f} is associated with face f and is a product of Pauli-Z matrices acting on all edges of f. The code space is defined as the simultaneous “+1” eigenstate of the operators Xᵥ and Z_{f}. These operators (or products of these operators) are called the stabilizers of the code. When an error has affected the qubits of the code, any stabilizer that anti-commutes with the error returns a “−1” measurement outcome. A subset of vertices with −1 measurement outcomes is called a syndrome σ. The syndrome σ can be used to determine a correction operator that, when applied to the code, corrects the error up to a stabilizer.

During execution of the quantum error correcting code 106, the quantum computing device 102 is configured to provide measurement data to the classical processor 104. The measurement data can be received as a batch or stream of data.

In conventional quantum error correction settings, the measurement data includes binary measurement outcomes, e.g., corresponding to stabilizer measurements. A detector is a parity of measurement outcome bits that is deterministic in the absence of errors. The outcome of a detector measurement is 1 if the observed parity differs from the expected parity for a noiseless computation and is 0 otherwise. A Pauli-type error P is said to flip a detector D if including P in the circuit changes the outcome of D, and a detection event is a detector with outcome 1. A logical observable is a linear combination of measurement bits, whose outcome corresponds to the measurement of a logical Pauli operator.

However, the physical measurements performed by the quantum computing device 102 typically do not produce binary measurement data. Instead, the measurement outcomes included in the measurement data are physically represented by much richer information, e.g., in-phase and quadrature phase components of measured signals (also referred to herein as I/Q phase space data) and are converted into binary measurement outcomes by additional processing that discards some information.

The example computing system 100 uses the I/Q phase space data to enhance decoding. That is, instead of providing binary measurement data to the classical processor 104, the quantum computing device is configured to provide measured I/Q phase space data 110 to the classical processor 104.

The classical processor 104 includes components for performing classical computations. For example, the classical processor 104 can be implemented as one or more computer programs, i.e., one or more modules of computer program instructions encoded on a tangible non-transitory storage medium for execution by, or to control the operation of, a data processing apparatus. The computer storage medium can be a machine-readable storage device, a machine-readable storage substrate, a random or serial access memory device, or a combination of one or more of them.

The classical processor 104 implements a decoder 112 that is configured to process the I/Q phase space data 110 received from the quantum computing device 102 and execute a decoding algorithm 114 using the processed I/Q phase space data to decode the data, i.e., predict which errors may have occurred during the quantum computation performed by the quantum computing device 102.

To execute the decoding algorithm 114 (also referred to herein as a decoding process), the decoder 112 maps the decoding problem onto a graph problem using a graph-like error model for the quantum error correcting code 106. A graph-like error model is an independent error model, i.e., a set of m independent error mechanisms, where error mechanism i occurs with probability p[i] (where p∈R^{m} is a vector of priors) and flips a set of detectors and observables. In a graph-like error model, each error mechanism flips at most two detectors. Graph-like error models can be used to approximate common noise models for many important classes of quantum error correction codes including surface codes, for which X-type and Z-type Pauli errors are both graph-like.

A graph-like error model is represented by a detector graph of nodes and edges G=(V,E), e.g., detector graph 116. Each node v∈V in the detector graph corresponds to a detector. Each edge e∈E is a set of detector nodes of cardinality one or two representing an error mechanism that flips this set of detectors. The set of edges E can be decomposed as E=E₁∪E₂ where for each edge e in E₁, |e|=1 and for each edge e in E₂, |e|=2. A regular edge e=(u, v)∈E₂ flips a pair of detectors u, v∈V, whereas a half-edge (u,)∈E₁ flips a single detector u∈V. A half-edge can be connected to a boundary of the detector graph, in which case the edge can be defined as (u, v_{b}) where v_{b} is a virtual boundary node (which does not correspond to any detector). In some implementations, e.g., when the graph problem is solved using minimum weight perfect matching, each edge can be assigned a weight that is determined by a respective error probability, e.g., w(eᵢ)=log log(1−p[i])/p[i]. Each edge can also be labelled with a set of logical observables that are flipped by the error mechanism, which is denoted either by l(eᵢ) or l(u, v) for eᵢ=(u, v)∈E. The distance D(u, v) between two nodes u and v in the detector graph is equal to the length of the shortest path between them.

Example decoding algorithms include minimum weight perfect matching (MWPM) and union find. MWPM decoding processes determine a most probable physical error consistent with syndromes in the measurement data. Detection events in measurement data are identified and labelled in the detector graph. A minimum weight embedded matching of the detection events in the detector graph is then determined, where an embedded matching of a set of detection events is a set of edges in the detector graph where each node corresponding to a detection event in the set of detection events is incident to an odd number of edges in the set of edges and each node that does not correspond to a detection event in the set of detection events is incident to an even number of edges in the set of edges. In conventional implementations of MWPM decoding processes, Edmond's blossom algorithm is used to determine the embedded matching, e.g., by seeding clusters of nodes in the detector graph using the detection events and growing, shrinking, or freezing the clusters until the minimum weight embedded matching is obtained. The embedded matching is used to determine a prediction of which logical observable measurements were flipped, which can in turn be used to determine a correction operator that, when applied to the quantum error correcting code 106, corrects the errors.

Union find decoding processes can be viewed as an approximation of minimum weight perfect matching decoding processes. A union find decoding process identifies detection events in measurement data and seeds clusters of nodes in the detector graph using the detection events. The clusters are then iteratively grown in the detector graph until the parity of the cluster changes. A so-called peeling step is then performed. A spanning tree for each grown cluster is generated and estimations of error are computed by traversing the spanning trees in reverse order. A correction operator that, when applied to the quantum error correcting code 106, corrects the errors is then determined.

As described above, before the decoder 112 executes the decoding algorithm 114, the decoder 112 is configured to process the I/Q phase space data 110 received from the quantum computing device 102. The processing can include classifying measurement outcomes of the multiple measurement operations performed by the quantum computing device 102 using respective in-phase and quadrature values and generating a detector graph of nodes and edges, where the detector graph labels detection events that occur in the classified measurement outcomes.

The processing can further include assigning weights to (or re-weighting) edges of the detector graph using posterior probability distributions of the classified measurement outcomes to generate a weighted detector graph. Usually, the edges are weighted according to an accumulated measurement error probability averaged over many shots. However, in the present disclosure the decoder 112 uses the I/Q phase space data 110 to reweight the edges according to prior distributions on the measurement outcomes. For example, were an I/Q data point to lie equidistant from the zero and one clouds in an I/Q data plot, assuming a uniform prior, the corresponding edge could be weighted using a 50% probability, indicating a high likelihood of that type of error. For points that lie near a higher-state cloud (e.g., the 2-state), this information can be used to reweight time-like edges in the vicinity with higher probabilities. This can compensate for the long-time effects of leakage, which may persist in the data qubits and cause correlated errors across long time durations.

In the context of superconducting qubits, e.g., transmon qubits, the three lowest-energy states |0), |1), |2) are typically considered. In a typical “discrete” point of view (where each measurement outcome is rigidly assigned to 0, 1, or 2), compromises must be made in terms of the “visibility” between the relevant states. However, in an error correction context, the typical prior probability of a qubit being leaked into |2) is ˜10₋₂ or less. By incorporating this prior and I/Q phase space data, the demands of |2) measurement fidelity can be relaxed, which allows for optimization of the measurement pulse parameters (e.g., frequency) primarily for 0/1 measurement.

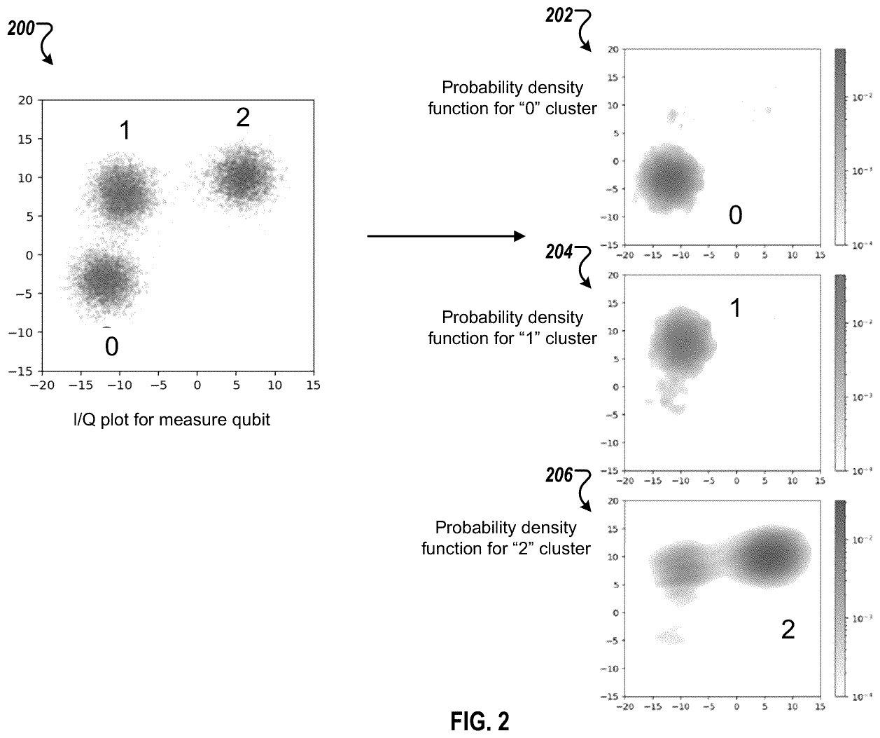

FIG. 2 shows a plot 200 of example measured I/Q phase space data and corresponding probability density functions generated from the example measured I/Q phase space data. Each point in plot 200 corresponds to an outcome of a measurement of a qubit. The x-axis represents the in-phase (I) component of the measurement outcome, and the y-axis represents the quadrature (Q) component of the measurement outcome, e.g., where the I and Q components are derived from a demodulated signal obtained from the qubit's response to a measurement pulse. As shown, for a given quantum state, repeated measurements will produce data points that cluster around specific regions in the I/Q plane. For example, when the qubit is prepared in the 0-state and measured, the resulting data points form the cluster (sometimes referred to a cloud) labelled “0”. Similarly, when the qubit is prepared in the 1-state and measured, the resulting data points form the cluster labelled “1”. Leakage of the qubit state outside of the computational subspace, e.g., to the 2-state, results in a separate cluster labelled “2”.

Plots 202, 204, and 206 show example probability density functions that model data points that correspond to the clusters “0”, “1”, and “2”, respectively. The probability density functions for the I/Q phase space data can be estimated by mapping each data point z=(I, Q) to probability density values f₀(z), f₁(z), and f₂(z), e.g., using kernel density estimation to estimate Gaussian parameters.

In some implementations estimated probability density functions can be adjusted to account for device-specific properties such as relaxation effects. For example, some devices may exhibit behavior where a 1-state decays to a 0-state. In these examples, it can be beneficial to adjust estimated probability density functions. This can be achieved by fitting to the form of a skewed distribution that represents qubit relaxation. The fitted distribution and a prior distribution on the measurement outcomes (obtained e.g., empirically by executing multiple quantum error correction circuits and determining how frequently a zero or one state is observed) to compute the posterior probabilities that would be used to reweight edges.

Alternatively, to avoid fitting to a skewed distribution (e.g., if the skewed distribution is not available), qubit-specific excess error obtained when trying to measure the 1 state can be obtained. The excess error P (0|1)−P(1|0) can be assumed to result entirely from relaxation effects during measurement. The posterior probability can then be updated whenever the 0 state is measured when in fact the 1 state was meant to be measured as Pr (“0-state was wrongly discriminated 0”)*(1−probability of relaxation)+(1−Pr(“−state was wrongly discriminated 0))*probability of relaxation. Both of the above described techniques treat 0-state measurements as less reliable due to the possibility of relaxation.

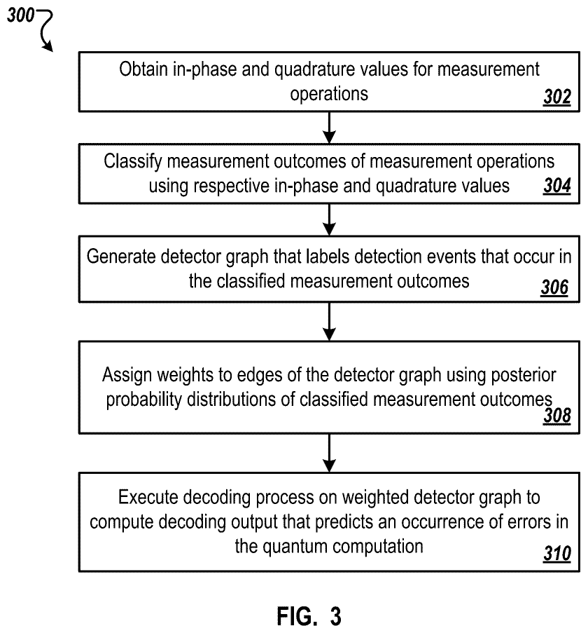

Returning to FIG. 1, the decoder 112 can then execute the decoding algorithm 114 on the weighted detector graph. Example operations performed by components of the decoder 112 are described in more detail below with reference to FIG. 3.

After the decoder 112 has completed decoding, the classical processor 104 is configured to output a correction operator 118. The correction operator 118 can be applied to the quantum error correcting code 106 to correct the errors identified by the decoder 112.

FIG. 3 is a flowchart of an example process 300 for enhancing decoding using in-phase and quadrature information. For convenience, the process 300 will be described as being performed by components of a classical computing system. For example, a classical computing system that includes a decoder, e.g., decoder 112 of FIG. 1 appropriately programmed, can perform example process 300.

The system obtains in-phase and quadrature values for multiple measurement operations on qubits that implement a quantum error correction code for a quantum computation (step 302). The system uses the in-phase and quadrature values to compute probability density functions for classified measurement outcomes, e.g., using kernel density estimation techniques, as described above with reference to FIG. 2.

The system provides the probability density functions to a classical decoder. To improve bandwidth usage when transmitting the values to the decoder, the system can restrict the transmission to a few bits, e.g., 2, 3, 4 or 5 bits per measurement operation, instead of sending full floating point numbers.

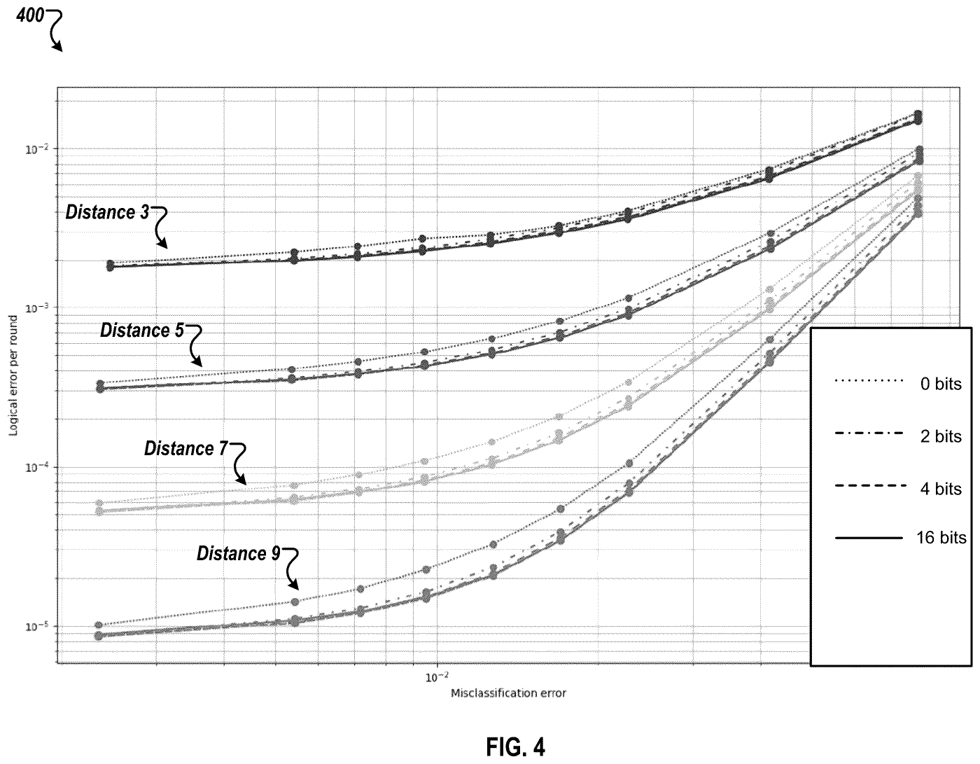

FIG. 4 is a plot 400 that shows misclassification error for different error correction code distances (d=3, 5, 7, and 9) and different transmission bit sizes (0, 2, 4, and 16). The x-axis represents misclassification error, and the y-axis represents logical error per round. As shown, for each code distance 3, 5, 6, and 9, increasing the bit transmission bit size from 0 (no I/Q information is provided) to 16 (the full probability density function values are transmitted) improves the logical error, however even transmitting a few bits of information, e.g., 2 or 4, quickly converges to the best case, e.g., where the full 16 bits are transmitted. This shows that the throughput to the decoder can be reduced without negatively affecting the error detection performed by the decoder.

In some implementations the number of bits of information transmitted can depend on whether detection events occur or not (e.g., the system can perform step 204 to identify detection events in measurement data and then determine how many bits of respective probability density functions to transmit to the decoder). For example, additional bits can be transmitted in the case that detection events occur. This means that, at low detection event fractions (e.g., <5%), 95% of the measurements would transmit no extra overhead.

Returning to FIG. 3, the decoder classifies measurement outcomes of the multiple measurement operations using respective in-phase and quadrature values, e.g., the probability density functions computed at step 302 (step 304). In cases where the measurement outcomes include binary outcomes, e.g., a first outcome 1 or a second outcome 0, the decoder computes a conditional probability that the measurement operation produces a first outcome given a respective in-phase and quadrature value assuming a uniform prior probability distribution for the measurement operation. For example, the decoder can compute

$$P r ( 1 \vert obs ) = \frac{P D {F}_{1} ( o b s )}{P D {F}_{0} ( o b s ) + P D {F}_{1} ( o b s )}$$

where Pr(1|obs) represents the conditional probability that the measurement operation produces outcome 1 given an in-phase and quadrature value obs, PDF₁(obs) represents a value of a probability density function PDF₁ for the outcome 1 and value obs, and PDF₀(obs) represents a value of a probability density function PDF₀ for the outcome 0 and value obs.

Then, the decoder determines whether the computed conditional probability is greater than or equal to a predetermined threshold or not, e.g., where the predetermined threshold is 0.5. In response to determining that the conditional probability is greater than or equal to a predetermined threshold, the decoder classifies the measurement outcome as the first outcome. In response to determining that the conditional probability is less than the predetermined threshold, the decoder classifies the measurement outcome as the second outcome.

In cases where the measurement outcomes include more than two outcomes, e.g., outcomes 0, 1, or 2, the decoder computes a conditional probability that the measurement operation produces outcome i given a respective in-phase and quadrature value assuming a prior probability distribution for the measurement operation. For example, the decoder can compute

$$Pr ( i \vert obs ) = \frac{{P}_{prior , i} \cdot {PDF}_{i} ( o b s )}{{\sum }_{j} {P}_{prior , j} \cdot {PDF}_{j} ( o b s )}$$

where Pr(i|obs) represents the conditional probability that the measurement operation produces outcome i given an in-phase and quadrature value obs, PDFₖ(obs) represents a value of a probability density function PDFₖ for outcome k and value obs, and the index j represents all possible measurement outcomes. The decoder can then determine whether the conditional probability is greater than or equal to a predetermined threshold that is based on the assumed prior.

The decoder generates a detector graph of nodes and edges, wherein the detector graph labels detection events that occur in the classified measurement outcomes (step 306). The decoder then assigns weights to the edges of the detector graph using posterior probability distributions of the classified measurement outcomes (and in some implementations measurements that discriminate leaked states) to generate a weighted detector graph (step 308). The weighted detector graph is equivalent to a detector graph generated with measurement error, where individual in-phase and quadrature values are used to determine measurement error probabilities.

In some implementations initial weights are assigned to edges of the detector graph using component-level benchmarks without measurement error. These initial weights can then be updated using the posterior probability distributions of the classified measurement outcomes.

When weights of a detector graph are initialized to instantiate the decoding algorithm, e.g., minimum-weight perfect matching, all errors that could contribute to a particular pattern of detection events are considered. One such pattern among these is the pattern caused by a particular measurement error. However, this pattern can be caused by other errors as well that are not the measurement error. Therefore, when this probability is updated, an error model that assumes there is no measurement error is generated. This ensures that, when adding in the probability of measurement error, the error is not counted twice. The initial probabilities can be taken by using pᵢₙᵢₜ (which represents the probability of all error mechanisms that flip the same set of detectors as a measurement error but are not a measurement error) and pₘₑₐₛ (which represents a probability of measurement error). The probability of the edge can then be updated as (1−pᵢₙᵢₜ)*pₘₑₐₛ+(1−pₘₑₐₛ)*pᵢₙᵢₜ.

The probability pᵢₙᵢₜ can be obtained from component level benchmarks. The probability pₘₑₐₛ can be obtained by (a) modeling the distribution of I/Q values conditioned on a true measurement of zero/one and (b) computing the probability that the I/Q value was drawn from the 0 distribution or the 1 distribution. This also requires a prior distribution on the probability that the bit was initially 0 or 1, but assuming that they are equally likely, this is the distribution with a higher PDF value at the sampled I/Q point. Finally, the posterior probability that the measurement was wrongly classified is computed as the conditional probability of the less likely outcome conditioned on the observed I/Q value (namely, Pr(“less likely outcome”)/(Pr(“more likely outcome”)+Pr(“less likely outcome”)). This is pₘₑₐₛ, which is then used to update the probability of the edge. The logarithm of that probability can then be taken to convert it to an edge weight (so that adding weights multiplies probabilities).

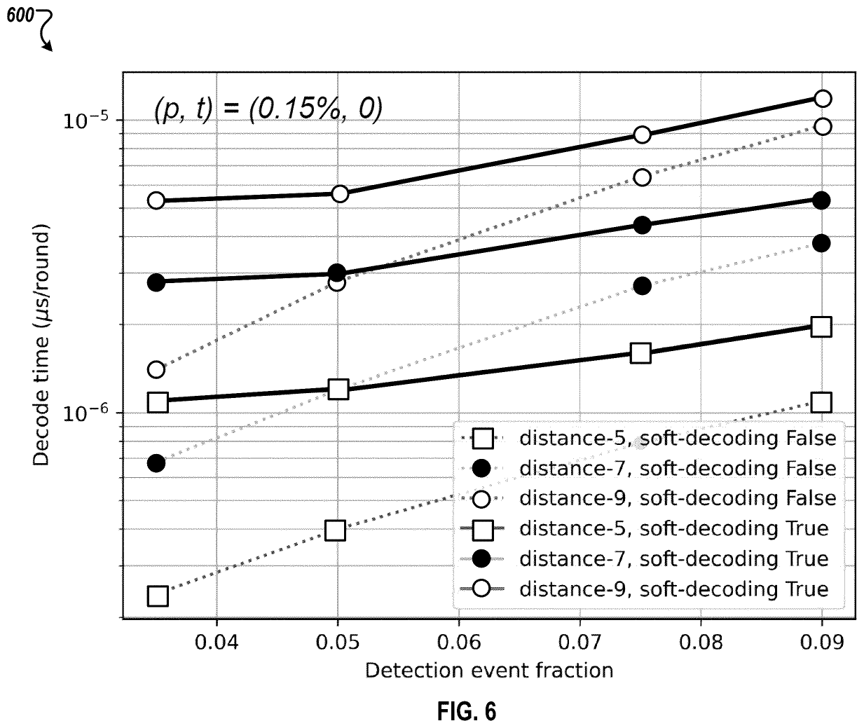

In some implementations only weights of edges that are adjacent to detection events are updated, e.g., to improve decoder speed as described below with reference to FIG. 6.

In some implementations leaked state discrimination information (e.g., information indicating when a qubit has been classified as being in a leaked state such as a 2-state) obtained from the in-phase and quadrature information is used to implement a leakage-aware reweighting strategy, where edges that correspond to qubits that have leaked or are close to a qubit that has leaked are down-weighted. In conventional settings, leakage to non-computational states e.g., the 2-state, is typically classified as a 1-state. However, this ignores additional information that the quantum computing device produces. A qubit in a leaked state changes the dynamics of the quantum computing device. For example, if a qubit is in a 2-state then the qubit might not correctly reset to the 0 state and stay in the 2-state. This in turn could affect qubits close to, e.g., coupled to, the qubit. Therefore, providing leaked state discrimination information to the decoder indicates that errors in the local area around the qubit in the leaked state (e.g., nearest neighbors) could be more likely.

In a leakage unaware decoder, a 2-state measurement would likely result in a highly likely 1-state discrimination. This is because 2-state I/Q clouds tend to lie near 1-state I/Q clouds but are very far from 0-state clouds. However, a leaked state could (and does) very frequently set of pairs of detection events that are well-separated in time. To reflect this, the decoder should attempt to make the measurement error edge very likely. One way to accomplish this is to have a leakage flag which triggers whenever the probability of the observed I/Q value lies at least two standard deviations away from either the 0- or 1-mean, indicating that it likely did not come from either. In this case, the measurement edge error can be replaced with 50%.

In some implementations all edges in the proximity of a leakage detection can be down weighted (as a leaked state interacting with a non-leaked state tends to de-phase the latter). This reflects the fact that leakage does not just cause measurement errors, but also all kinds of errors.

The decoder executes a decoding process on the weighted detector graph to compute a decoding output of the decoding process, where the decoding output predicts an occurrence of errors in the quantum computation (step 210). For example, the decoder can decode a number, e.g., 10⁷ shots of rounds of decoding using the weighted detector graph as part of a memory experiment to assess the performance of a particular decoding scheme (multiple rounds per shot are run to account for boundary effects that prevent very small number of rounds from generalizing to large numbers of rounds (the intended use case)).

In some implementations the presently described techniques can be implemented in a streaming, where a streaming decoding problem is divided into multiple finite blocks, where finite decoders are run on respective blocks. In these implementations, the presently described I/Q reweighting can be incorporated block-by-block, treating each as its own independent finite decoding problem.

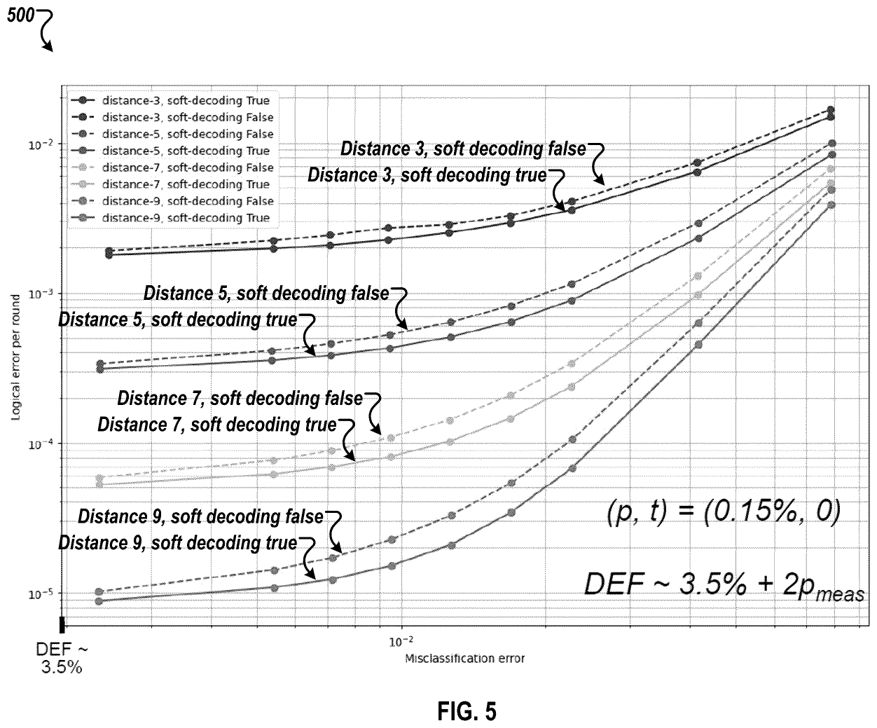

FIG. 5 is a plot 500 that shows misclassification error for different error correction code distances (d=3, 5, 7, and 9) using the presently described techniques for enhancing decoding using in-phase and quadrature information (labelled “soft decoding TRUE”) and without using the presently described techniques for enhancing decoding using in-phase and quadrature information (labelled “soft decoding FALSE”). The x-axis represents misclassification error and the y-axis represents logical error per round. As shown, for each code distance 3, 5, 6, and 9, enhancing decoding using in-phase and quadrature information improves the logical error, where the advantage increases with increasing code distance. The plotted data was taken with a circuit-level error rate of 0.15%. Under this error model, the value of I/Q decoding is pronounced around measurement error rates of 1%, precisely the realm of superconducting measurement error rates.

FIG. 6 is a plot 600 that shows the detection event fraction for different error correction code distances (d=5, 7, and 9) using the presently described techniques for enhancing decoding using in-phase and quadrature information (labelled “soft decoding TRUE”) and without using the presently described techniques for enhancing decoding using in-phase and quadrature information (labelled “soft decoding FALSE”). The x-axis represents detection event fraction, and the y-axis represents decode time (microseconds per round). As shown, for each code distance 5, 6, and 9, enhancing decoding using in-phase and quadrature information slightly increases the decode time, particularly at lower error rates (measured as a detection event fraction). When the error rate increases, decoding using in-phase and quadrature information and not using in-phase and quadrature information takes a similar amount of time.

In conventional matching decoders that do not implement the presently described techniques, after each execution of the decoder, all of the edges in the detector graph are reset. In the low error regime, conventional matching decoders typically have a runtime that scales approximately as proportional to the number of vertices in the detector multiplied by the detection event fraction. In implementations of the presently described techniques, a number of edges that is proportional to the number of graph vertices will be reweighted, which increases the runtime as shown (increases to proportional to the number of vertices). This computational expense can be mitigated by trading accuracy for speed and only reweighting edges in the detector graph that are adjacent to detection events, as described above with reference to FIG. 3.

Implementations of the subject matter and operations described in this specification can be implemented in digital electronic circuitry, analog electronic circuitry, suitable quantum circuitry or, more generally, quantum computational systems, in tangibly-embodied software or firmware, in computer hardware, including the structures disclosed in this specification and their structural equivalents, or in combinations of one or more of them. The term “quantum computational systems” may include, but is not limited to, quantum computers, quantum information processing systems, quantum cryptography systems, or quantum simulators.

Implementations of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, one or more qubits, or a combination of one or more of them. Alternatively, or in addition, the program instructions can be encoded on an artificially-generated propagated signal that is capable of encoding digital and/or quantum information, e.g., a machine-generated electrical, optical, or electromagnetic signal, that is generated to encode digital and/or quantum information for transmission to suitable receiver apparatus for execution by a data processing apparatus.

The terms quantum information and quantum data refer to information or data that is carried by, held or stored in quantum systems, where the smallest non-trivial system is a qubit, i.e., a system that defines the unit of quantum information. It is understood that the term “qubit” encompasses all quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, multiple digital and quantum processors or computers, and combinations thereof. The apparatus can also be, or further include, special purpose logic circuitry, e.g., an FPGA (field programmable gate array), an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL or Quipper.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a digital and/or quantum data communication network. A quantum data communication network is understood to be a network that may transmit quantum data using quantum systems, e.g., qubits. Generally, a digital data communication network cannot transmit quantum data, however a quantum data communication network may transmit both quantum data and digital data.

The processes and logic flows described in this specification can be performed by one or more programmable computers, operating with one or more processors, as appropriate, executing one or more computer programs to perform functions by operating on input data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more computers to be “configured to” perform particular operations or actions means that the system has installed on its software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For example, a quantum computer may receive instructions from a digital computer that, when executed by the quantum computing apparatus, cause the apparatus to perform the operations or actions.

Computers suitable for the execution of a computer program can be based on general or special purpose processors, or any other kind of central processing unit. Generally, a central processing unit will receive instructions and data from a read-only memory, a random access memory, or quantum systems suitable for transmitting quantum data, e.g., photons, or combinations thereof.

The elements of a computer include a central processing unit for performing or executing instructions and one or more memory devices for storing instructions and digital, analog, and/or quantum data. The central processing unit and the memory can be supplemented by, or incorporated in, special purpose logic circuitry or quantum simulators. Generally, a computer will also include, or be operatively coupled to receive data from or transfer data to, or both, one or more mass storage devices for storing data, e.g., magnetic, magneto-optical disks, optical disks, or quantum systems suitable for storing quantum information. However, a computer need not have such devices.

Quantum circuit elements (also referred to as quantum computing circuit elements) include circuit elements for performing quantum processing operations. That is, the quantum circuit elements are configured to make use of quantum-mechanical phenomena, such as superposition and entanglement, to perform operations on data in a non-deterministic manner. Certain quantum circuit elements, such as qubits, can be configured to represent and operate on information in more than one state simultaneously. Examples of superconducting quantum circuit elements include circuit elements such as quantum LC oscillators, qubits (e.g., flux qubits, phase qubits, or charge qubits), and superconducting quantum interference devices (SQUIDs) (e.g., RF-SQUID or DC-SQUID), among others.

In contrast, classical circuit elements generally process data in a deterministic manner. Classical circuit elements can be configured to collectively carry out instructions of a computer program by performing basic arithmetical, logical, and/or input/output operations on data, in which the data is represented in analog or digital form. In some implementations, classical circuit elements can be used to transmit data to and/or receive data from the quantum circuit elements through electrical or electromagnetic connections. Examples of classical circuit elements include circuit elements based on CMOS circuitry, rapid single flux quantum (RSFQ) devices, reciprocal quantum logic (RQL) devices and ERSFQ devices, which are an energy-efficient version of RSFQ that does not use bias resistors.

In certain cases, some or all of the quantum and/or classical circuit elements may be implemented using, e.g., superconducting quantum and/or classical circuit elements. Fabrication of the superconducting circuit elements can entail the deposition of one or more materials, such as superconductors, dielectrics and/or metals. Depending on the selected material, these materials can be deposited using deposition processes such as chemical vapor deposition, physical vapor deposition (e.g., evaporation or sputtering), or epitaxial techniques, among other deposition processes. Processes for fabricating circuit elements described herein can entail the removal of one or more materials from a device during fabrication. Depending on the material to be removed, the removal process can include, e.g., wet etching techniques, dry etching techniques, or lift-off processes. The materials forming the circuit elements described herein can be patterned using known lithographic techniques (e.g., photolithography or e-beam lithography).

During operation of a quantum computational system that uses superconducting quantum circuit elements and/or superconducting classical circuit elements, such as the circuit elements described herein, the superconducting circuit elements are cooled down within a cryostat to temperatures that allow a superconductor material to exhibit superconducting properties. A superconductor (alternatively superconducting) material can be understood as material that exhibits superconducting properties at or below a superconducting critical temperature. Examples of superconducting material include aluminum (superconductive critical temperature of 1.2 kelvin) and niobium (superconducting critical temperature of 9.3 kelvin). Accordingly, superconducting structures, such as superconducting traces and superconducting ground planes, are formed from material that exhibits superconducting properties at or below a superconducting critical temperature.

In certain implementations, control signals for the quantum circuit elements (e.g., qubits and qubit couplers) may be provided using classical circuit elements that are electrically and/or electromagnetically coupled to the quantum circuit elements. The control signals may be provided in digital and/or analog form.

Computer-readable media suitable for storing computer program instructions and data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a computer program product that includes instructions that are stored on one or more non-transitory machine-readable storage media, and that are executable on one or more processing devices. The systems described in this specification, or portions of them, can each be implemented as an apparatus, method, or system that may include one or more processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer implemented method comprising:
obtaining in-phase and quadrature values for multiple measurement operations in a quantum error correction code for a quantum computation;
classifying measurement outcomes of the multiple measurement operations using respective in-phase and quadrature values;
generating a detector graph of nodes and edges, wherein the detector graph labels detection events that occur in the classified measurement outcomes;
assigning weights to the edges of the detector graph using posterior probability distributions of the classified measurement outcomes to generate a weighted detector graph; and
executing a decoding process on the weighted detector graph to compute a decoding output of the decoding process, wherein the decoding output predicts an occurrence of errors in the quantum computation.

2. The method of claim 1, further comprising using the in-phase and quadrature values to compute probability density functions for the classified measurement outcomes, optionally wherein computing the probability density functions for the measurement outcomes comprises using kernel density estimation techniques.

3. The method of claim 1, wherein classifying measurement outcomes of the multiple measurement operations using respective in-phase and quadrature values comprises, for each measurement operation:
computing a conditional probability that the measurement operation produces a first outcome given a respective in-phase and quadrature value assuming a uniform prior probability distribution for the measurement operation; and
in response to determining that the conditional probability is greater than or equal to a predetermined threshold, classifying the measurement outcome as the first outcome; or
in response to determining that the conditional probability is less than the predetermined threshold, classifying the measurement outcome as a second outcome.

4. The method of claim 3, wherein computing a conditional probability that the measurement operation produces a first outcome given a respective in-phase and quadrature value assuming a uniform prior probability distribution comprises computing:
$$Pr ( 1 \vert obs ) = \frac{P D {F}_{1} ( o b s )}{P D {F}_{0} ( o b s ) + P D {F}_{1} ( o b s )}$$
where Pr(1|obs) represents the conditional probability that the measurement operation produces outcome 1 given an in-phase and quadrature value obs, PDF₁(obs) represents a value of a probability density function PDF₁ for the outcome 1 given the value obs, and PDF₀(obs) represents a value of a probability density function PDF₀ for the outcome 0 given the value obs.

5. The method of claim 1, wherein classifying measurement outcomes of the multiple measurement operations using respective in-phase and quadrature values comprises, for each measurement operation:
computing a conditional probability that the measurement operation produces outcome i given a respective in-phase and quadrature value assuming a prior probability distribution for the measurement operation.

6. The method of claim 5, wherein computing a conditional probability that the measurement operation produces outcome i given a respective in-phase and quadrature value assuming a uniform prior probability distribution comprises computing:
$$Pr ( i \vert obs ) = \frac{{P}_{prior , i} \cdot {PDF}_{i} ( o b s )}{{\sum }_{j} {P}_{prior , j} \cdot {PDF}_{j} ( o b s )}$$
where Pr(i|obs) represents the conditional probability that the measurement operation produces outcome i given an in-phase and quadrature value obs, PDFₖ(obs) represents a value of a probability density function PDFₖ for outcome k given the value obs, and the index j represents all possible measurement outcomes.

7. The method of claim 1, wherein generating the detector graph comprises assigning the edges initial weights using component-level benchmarks without measurement error.

8. The method of claim 7, assigning weights to the edges of the detector graph using posterior probability distributions of the classified measurement outcomes comprises updating the initial weights to include values of the posterior probability distributions.

9. The method of claim 1, wherein the weighted detector graph is equivalent to a detector graph generated with measurement error, wherein individual in-phase and quadrature values are used to determine measurement error probabilities.

10. The method of claim 1, wherein the in-phase and quadrature values are obtained from a quantum computing device that implements the quantum error correction code and performs the quantum computation, wherein the quantum computing device transmits 4 additional bits of in-phase and quadrature values per measurement operation.

11. The method of claim 1, wherein assigning weights to the edges of the detector graph using posterior probability distributions of the classified measurement outcomes to generate a weighted detector graph comprises updating weights of edges that are adjacent to detection events.

12. The method of claim 1, wherein assigning weights to the edges of the detector graph using posterior probability distributions of the classified measurement outcomes to generate a weighted detector graph comprises down-weighting weights of edges that are adjacent to detection events and that include leakage measurements.

13. The method of claim 1, wherein in-phase and quadrature values for a respective measurement operation are clustered into a first cluster that represents a 0 measurement outcome of the measurement operation, a 1 measurement outcome of the measurement operation, and a 2 measurement outcome of the measurement operation, wherein the 2 measurement outcome indicates leakage.

14. The method of claim 1, further comprising using leaked state discrimination to implement a leakage-aware reweighting strategy.

15. A system comprising:
one or more data processing apparatuses; and
non-transitory computer readable storage media in data communication with the one or more data processing apparatuses and storing instructions that, when executed by the data processing apparatuses, cause the one or more data processing apparatuses to perform operations comprising:
obtaining in-phase and quadrature values for multiple measurement operations in a quantum error correction code for a quantum computation;
classifying measurement outcomes of the multiple measurement operations using respective in-phase and quadrature values;
generating a detector graph of nodes and edges, wherein the detector graph labels detection events that occur in the classified measurement outcomes;
assigning weights to the edges of the detector graph using posterior probability distributions of the classified measurement outcomes to generate a weighted detector graph; and
executing a decoding process on the weighted detector graph to compute a decoding output of the decoding process, wherein the decoding output predicts an occurrence of errors in the quantum computation.

16. A computer-readable storage medium comprising instructions stored thereon that are executable by a processing device and upon such execution cause the processing device to perform operations comprising:
obtaining in-phase and quadrature values for multiple measurement operations in a quantum error correction code for a quantum computation;
classifying measurement outcomes of the multiple measurement operations using respective in-phase and quadrature values;
generating a detector graph of nodes and edges, wherein the detector graph labels detection events that occur in the classified measurement outcomes;
assigning weights to the edges of the detector graph using posterior probability distributions of the classified measurement outcomes to generate a weighted detector graph; and
executing a decoding process on the weighted detector graph to compute a decoding output of the decoding process, wherein the decoding output predicts an occurrence of errors in the quantum computation.

17. A computer program product comprising instructions which, when the program is executed by one or more processing devices, cause the one or more processing devices to carry out operations comprising:
obtaining in-phase and quadrature values for multiple measurement operations in a quantum error correction code for a quantum computation;
classifying measurement outcomes of the multiple measurement operations using respective in-phase and quadrature values;
generating a detector graph of nodes and edges, wherein the detector graph labels detection events that occur in the classified measurement outcomes;
assigning weights to the edges of the detector graph using posterior probability distributions of the classified measurement outcomes to generate a weighted detector graph; and
executing a decoding process on the weighted detector graph to compute a decoding output of the decoding process, wherein the decoding output predicts an occurrence of errors in the quantum computation.
